(19) United States
(12) Patent Application Publication
(10) Pub. No.: US 2025/0117675 A1
(43) Pub. Date: Apr. 10, 2025

(54) SOFT-SENSING METHOD FOR DIOXIN EMISSIONS OF MSWI PROCESS BASED ON ENSEMBLE T-S FUZZY REGRESSION TREE

(71) Applicant: BEIJING UNIVERSITY OF TECHNOLOGY, Beijing (CN)

(72) Inventors: Jian TANG, Beijing (CN); Heng XIA, Beijing (CN); Canlin CUI, Beijing (CN); Junfei QIAO, Beijing (CN)

(73) Assignee: BEIJING UNIVERSITY OF TECHNOLOGY, Beijing (CN)

(21) Appl. No.: 18/856,902

(22) PCT Filed: Apr. 27, 2023
(86) PCT No.: PCT/CN2023/091239

§ 371 Date: Oct. 15, 2024

(30) Foreign Application Priority Data
May 31, 2022 (CN) 202210611985.6

(51) Int. Cl. G06N 5/048

(52) U.S. Cl. CPC G06N 5/048

(57) ABSTRACT

The provided is a Soft-sensing method for dioxin emissions of MSWI process based on ensemble T-S fuzzy regression tree. The highly toxic pollutant dioxins (DXN) generated in the municipal solid waste incineration (MSWI) process based on a grate furnace is a key environment index for realizing operation optimization control of the process. The method comprises the following steps: firstly, constructing a dioxin emission TSFRT model based on a screening layer and a fuzzy reasoning layer; then, a plurality of parameter updating learning algorithms aiming at the fuzzy reasoning antecedent part and the fuzzy reasoning consequent part are provided, and five dioxin emission TSFRT models including TSFRT-I, TSFRT-II, TSFRT-III, TSFRT-IV and TSFRT-V are obtained; finally, by taking the dioxin emission TSFRT-III model as an example, constructing an integrated TSFRT (EnTSFRT) model taking the TSFRT-III as a base learner so as to realize high-precision modeling of the dioxin emission concentration.

### TECHNICAL FIELD

The invention belongs to the technical field of soft measurement.

### BACKGROUND TECHNOLOGY

Municipal solid waste (MSW) treatment aims to achieve decontamination, reduction and recycling. In recent years, China accounts for about 9% of the world's dioxin (DXN) emissions, of which MSW incineration (MSWI) is one of the main industrial processes of DXN emissions, accounting for about 9% of the total emissions. MSWI mainly adopts technologies such as grate furnace, fluidized bed and rotary kiln, among which grate furnace accounts for the largest proportion in China. In addition, the grate furnace-based MSWI will make an important contribution to the reduction of DXN emissions in my country in the future. Therefore, high-precision soft measurement of DXN emissions is a top priority for MSWI process control.

Data-driven soft sensing technology can effectively solve the above problems, that is, to establish the mapping relationship between easily measurable process variables and DXN emission concentrations by means of machine learning or deep learning. This usually requires the determination of a mapping function to predict DXN emissions. However, most of the existing methods lack interpretability and are difficult to deal with the uncertainty of the real process, and the generalization performance of the model needs to be improved.

Fuzzy decision tree (FDT) uses a branch-bound backtracking mechanism to build a classification decision model that can deal with the nature of uncertainty. Subsequently, clear decision trees (CDTs) such as CART, ID3 and C4.5 are proposed. Studies have shown that the CDT model has strong robustness and can become an extremely convenient interpretable white-box algorithm just by adjusting the hyperparameters. In addition, fuzzy set theory, which is the main pattern recognition technique, has attracted extensive attention, and then many studies on fuzzy classification trees (FCT) have emerged. For example, fuzzy partitioning is used to construct an FCT model for data with clear semantic information, an FCT method that combines ID3 tree with fuzzy approximate reasoning, and a complete FCT model including growth, pruning, fine-tuning, and testing processes. Therefore, the pattern recognition technology that combines fuzzy theory with CDT, namely FCT algorithm, has become one of the research hotspots that can deal with problems with uncertain characteristics. Currently, FCT is widely used in sign language recognition, partial discharge pattern classification, sorting tasks, sample selection, data mining, visual classification, distributed computing and other classification tasks, but it is difficult to directly apply to the DXN emission concentration faced by the present invention Predictive regression task.

Facing the soft measurement problem of DXN emission concentration, the present invention firstly constructs a dioxin emission TSFRT model based on a screening layer and a fuzzy inference layer; then, a variety of parameter updating learning algorithms are proposed for the preparts and postparts of fuzzy inference to obtain TSFRT-I, TSFRT-II, TSFRT-III, TSFRT-IV and TSFRT-V, a total of five dioxin emission TSFRT models; Finally, the integrated TSFRT(EnTSFRT) model based on TSFRT-III is constructed to achieve high-precision modeling of dioxin emission concentration. Experimental results on real DXN data sets show the validity and rationality of the proposed method.

The MSWI process includes process stages such as solid waste storage and transportation, solid waste incineration, waste heat boiler, steam power generation, flue gas purification and flue gas emission. Taking the grate MSWI process with a daily processing capacity of 800 tons as an example, the process flow is as follows FIG. 1 shown.

Combined with the whole process of DXN decomposition, generation, adsorption and discharge, the main functions of each stage are described as follows:
1) Solid waste storage and transportation stage: Sanitation vehicles transport MSW from various collection sites in the city to MSWI power plant. After weighing and recording, they are dumped from the unloading platform to the unfermented area in the solid waste storage pool, and then the solid waste grab bucket is used to dispose of it. Carry out mixing and stirring, and then grab it to the fermentation area, and ferment and dehydrate for 3 to 7 days to ensure the low calorific value of MSW incineration. Studies have shown that virgin MSW contains a trace amount of DXN (about 0.8ng TEQ/Kg), and contains a variety of chlorine-containing compounds required for the DXN generation reaction.
2) Solid waste incineration stage: The solid waste grab puts the fermented MSW into the feeding hopper, and pushes the MSW into the incinerator through the feeder. After drying, first burning, second burning and burning the grate, the combustible components in the MSW are then completely burned; the required combustion air is injected from the lower part of the grate and the middle of the furnace by the primary fan and the secondary fan, and the ash produced by the final combustion falls from the end of the burning grate to the slag machine, and is cooled by water. Then sent to the slag pool. In order to ensure that the DXN contained in the original MSW and generated during incineration can be completely decomposed under the high temperature combustion conditions in the furnace, the furnace combustion process needs to strictly control the flue gas temperature above 850° C., and the high temperature flue gas residence time in the furnace for more than 2 seconds to ensure a sufficient degree of flue gas turbulence and other process requirements.
3) Waste heat boiler stage: the high temperature flue gas (above 850° C.) generated by the furnace is sucked into the waste heat boiler system by the induced draft fan, and successively passes through the superheater, the evaporator and the economizer equipment, the high temperature flue gas and the liquid water in the boiler drum. After heat exchange, high-temperature steam is generated, and then the cooling treatment of high-temperature flue gas is realized, so that the flue gas temperature at the outlet of the waste heat boiler is lower than 200° C. (ie, flue gas G1). From the perspective of the DXN generation mechanism, when the high temperature flue gas is cooled by the waste heat boiler, the chemical reactions leading to the generation of DXN include high temperature gas phase synthesis reaction (800° C.-500° C.), precursor synthesis (450° C.-200° C.) and de novo synthesis (350° C.-250° C.), etc., but there is no unified conclusion yet.
4) Steam power generation stage: The high-temperature steam generated by the waste heat boiler is used to drive the turbine generator, and the mechanical energy is converted into pure electric energy, so as to realize the self-sufficiency of plant-level electricity consumption and the grid-connected power supply of surplus electricity, so as to realize resource utilization and obtain economic benefits.
5) Flue gas purification stage: The flue gas purification of the MSWI process mainly includes denitrification (NOx), desulfurization (HCL, HF, SO₂, etc.), removal of heavy metals (Pb, Hg, Cd, etc.), adsorption of dioxins (DXN) and dust removal. (particulate matter) and a series of processes, and then achieve the goal of incineration flue gas pollutant emission compliance. The use of activated carbon injection system to adsorb DXN in incineration flue gas is the most widely used technical means at present, and all the adsorbed DXN is enriched in fly ash.
6) Flue gas emission stage: The incineration flue gas (ie flue gas G2) containing a trace amount of DXN after cooling and purification treatment is sucked by the induced draft fan and discharged into the atmosphere through the chimney. The uninterrupted and long-term operation characteristics of the MSWI process lead to a large amount of DXN attached to the particles on the inner wall of the chimney (that is, the memory effect).

At present, the DXN soft sensing detection research for MSWI process mainly focuses on the DXN concentration detection in the emission stage (ie, flue gas G3). This paper focuses on building a DXN emission soft sensing model at G3 flue gas.

### CONTENT OF THE INVENTION

The basic definition of T-S fuzzy reasoning and describe the regression-oriented BDT construction process is discussed.

T-S fuzzy reasoning is first proposed by Takagi and Sugeno and is widely used in modeling, control and parameter identification.

For the complex industrial system which having M input features x=[x₁ . . . xₘ . . . x_{M}]∈R^{1×M}, its output y is a continuous value, and the modeling data set is recorded as D={xᵢ, yᵢ}ᵢ₋₁^{N} ∈R ^{N×M+1}, wherein N represents the number of modeling data,

Basic definition of T-S fuzzy reasoning is as follows:

For M input features X=[x₁ . . . Xₘ . . . X_{M}]∈ R^{1×M}, using K IF-THEN fuzzy rules to describe the local linear relationship, where the kth fuzzy rule is expressed as:

$${R}_{k} : if {x}_{1} is {A}_{1}^{k} and … and {x}_{m} is {A}_{m}^{k} and … and {x}_{M} is {A}_{M}^{k} then \qquad ( 1 )$$

$${ϕ}_{k} = {g}^{k} ( {x}_{1} , … , {x}_{M} )$$

Wherein, the meaning of Rₖ is: when x₁ is A₁ ^{k} and . . . and Xₘ is Aₘ^{k} and . . . and ϕₖ=g^{k}(X₁, . . . ,x_{M})when xₘ is Aₘ^{k}, Aₗ^{k}, Aₘ ^{k} and A_{M}^{k} respectively represent the fuzzy set specified by the membership function of X₁, xₘ and x_{M}; ϕₖ represents an output of the kth fuzzy rule, g^{k} (xₗ, . . . , x_{M}) is expressed as:

$${g}^{k} ( {x}_{1} , … , {x}_{M} ) = {ω}_{1} {x}_{1} + {ω}_{2} {x}_{2} + … + {ω}_{M} {x}_{M} \qquad ( 2 )$$

Wherein ω₁, ω₂ and ωₘ. are the weight corresponding to x₁, x₂ and xₘ.

Therefore, T-S fuzzy inference system f,s (x) based on K fuzzy rules {Rₖ}ₖ₌₁ ^{k} is expressed as follows:

$${f}_{T - S} ( x ) = \frac{{\sum }_{k = 1}^{K} ( {\prod }_{m = 1}^{M} {A}_{m}^{k} ) {ϕ}_{k}}{{\sum }_{k = 1}^{K} ( {\prod }_{m = 1}^{M} {A}_{m}^{k} )} = \frac{{\sum }_{k = 1}^{K} ( {\prod }_{m = 1}^{M} {A}_{m}^{k} ) {g}_{i}^{k} ( {x}_{1} , … , {x}_{M} )}{{\sum }_{k = 1}^{K} ( {\prod }_{m = 1}^{M} {A}_{m}^{k} )} \qquad ( 3 )$$

Wherein,

$${\prod }_{m = 1}^{M} {A}_{m}^{k}$$

represents a fuzzy operations between fuzzy set {A₁^{k}, . . . ,Aₘ^{k}, . . . , A_{M}^{k}, which usually use t-norms, s-norms or Cartesian product.

In the invention, the CART algorithm in binary decision tree (BDT) is used for regression modeling. BDT in constructed by a feature set (clear set) {Pcs(μ_{CS}¹(·) . . . μ_{CS}^{m}(·) . . . }⊆{xᵢ}ᵢ₌₁ ^{N} which is a top-down recursive segmentation dataset, which is shown is FIG. 2.

To implement a top-down recursive process, clear set theory is applied in all non-leaf nodes. Suppose the BDT model is composed of T_{node} nodes. Therefore, the number of non-leaf nodes is T_{node}/2-1, and the membership function of the clear set is expressed as {μ_{CS}^{t}(·)}ₜ₌₁^{T}^{_{node}}^{/2-1},the t-th membership function is expressed as follows:

$${μ}_{CS}^{t} ( {x}_{i} ) = \{ \begin{matrix}1 , & if {x}_{i , m} \geq {δ}_{t} \\ 0 , & if {x}_{i , m} < {δ}_{t}\end{matrix} , t = 1 , … , ( {T}_{node} / 2 - 1 ) \qquad ( 4 )$$

Wherein, μ_{CS}(xᵢ) represents clear membership function of xᵢ, δₜ, is the segmentation node of the t-th membership function, determined by minimizing the mean square error (MSE), and the calculation process is as follows:

$$Ω = {arg min}_{{δ}_{t}} [ {f}_{MSE} ( {D}_{Left} ) + {f}_{MSE} ( {D}_{Right} ) ] = {arg min}_{{δ}_{t}} [ {( ( {y}_{Left} - {ϑ}_{t}^{Left} ) {μ}_{CS}^{t} ( {x}_{t} ) )}^{2} + {( ( {y}_{Right} - {ϑ}_{t}^{Right} ) {μ}_{CS}^{t} ( {x}_{t} ) )}^{2} ] \qquad ( 5 )$$

Wherein, Ω is the loss value; f_{MSE} (D_{Left}) and f_{MSE} (D_{Right}) respectively represents the MSE of left subset D_{Left} and right subset D_{Right}; y_{Left} and y_{Right} respectively represents the true value vector of left subset D_{Left} and right subset D_{Right}; ϑRight respectively represents the mean of the target values of left subset D_{Left} and right subset D_{Right}.

$${ϑ}_{t}^{Left} = \frac{1}{{N}_{Subset}^{Left}} {\sum }_{i = 1}^{{N}_{Subset}^{Left}} {y}_{Left , i} \qquad ( 6 )$$

$${ϑ}_{t}^{Right} = \frac{1}{{N}_{Subset}^{Right}} {\sum }_{i = 1}^{{N}_{Subset}^{Right}} {y}_{Right , i} \qquad ( 7 )$$

Wherein, N_{Subset}^{Left} and N_{Subset}^{Right} respectively represents the number of sample of left subset D_{Left} and right subset D_{Right};y_{Left,i} and y_{Right,i} respectively represents the i-th true value of y_{Left} and y_{Right}.

Therefore, the BDT model can be expressed as:

$${f}_{CDT} ( x ) = {\sum }_{{t}_{leaf} = 1}^{T / 2} {ϑ}_{{t}_{leaf}} {\{ {μ}_{CS}^{t} ( {x}_{i} ) \}}_{t = 1}^{T / 2 - 1} \qquad ( 8 )$$

Wherein, ϑₜ_{_{leaf}} is the mean value of the t_{leaf}-th leaf nodes.

Modeling of DXN emission concentration based on Integrated T-S fuzzy regression tree:

Firstly, the structure of the DXN emission concentration TSFRT model is introduced; then, the learning algorithm of the TSFRT model is provided; finally, the DXN emission concentration EnTSFRT model is proposed.

4.1 Construction of DXN emission concentration TSFRT model:

DXN emission concentration TSFRT model includes a screening layer (clear set) and a fuzzy inference layer (fuzzy set), wherein: the screening layer is used for feature screening, and the fuzzy inference layer is used for T-S fuzzy inference, which is shown is FIG. 3:

In screening layer, the input is training dataset D={xᵢ, yᵢ}_{i×1}^{N}∈R^{N×M+1}. First, each eigenvalue in dataset D is traversed and its MSE value is calculated using formula (5). Then, he first degree of membership μ_{CS}¹ (·) in clear set C_{CS}^{t}^{_{leaf}} is obtained by minimum MSE.

Therefore, dataset D is divided into two left and right subsets as follows:

$$\{ \begin{matrix}{D}_{Left} : \{ {D}_{Left} ∈ {R}^{{N}_{Left} \times M} \vert {μ}_{CS}^{1} ( x ) ≡ 1 \} \\ {D}_{Right} : \{ {D}_{Right} ∈ {R}^{{N}_{Right} \times M} \vert {μ}_{CS}^{1} ( x ) ≡ 0 \}\end{matrix} \qquad ( 9 )$$

Wherein, {D_{Left}∈R^{N}^{_{Left}}^{×M}|μ_{CS}¹(x)≡1} represents left subset D_{Left} belongs to N_{Left}×M real number space when μ_{CS}¹(x)=1, {D_{Right}∈R^{N}^{_{Right}}^{×M}|μ_{CS}¹(x)≡0}represents right subset D_{Right} belongs to N_{Right}×M real number space when μ_{CS} ¹(x)≡0}.

The first element (δ₁=x_{i,m}) in C_{CS}^{t}^{_{leaf}} is determined by formula (4), expressed as follows:

$${C}_{CS}^{{t}_{leaf}} : \{ {μ}_{CS}^{1} ( x ) \} \qquad ( 10 )$$

Repeating the above process, the DXN emission concentration TSFRT model exists T_{node}/2-1 internal nodes. Therefore, T_{node}/2 subsets {D_{subset}^{t}}ₜ₌₁ ^{T}^{_{node}}^{/2} is generated. The t^{leaf} clear set {C_{CS}^{t}^{_{leaf}}}tₜ_{_{leaf}} ₌₁ ^{T}^{_{node}}^{/2} is expressed as:

$${C}_{CS}^{{t}_{leaf}} : \{ {μ}_{CS}^{1} ( x ) , … , {μ}_{CS}^{t} ( x ) \vert t ≪ ( {T}_{node} / 2 ) - 1 \} \qquad ( 11 )$$

The simplified form is:

$${C}_{CS}^{{t}_{leaf}} : \{ {δ}_{1} , … , {δ}_{t} \vert t ≪ ( {T}_{node} / 2 ) - 1 \} \qquad ( 12 )$$

Therefore, the input representation of the resulting T-S fuzzy inference of the t_{leaf}-th clear set {C_{CS}^{t}^{_{leaf}}}ₜ_{_{leaf}}₌₁^{T}^{_{node}}^{/2} is as follows:

$${D}^{{t}_{leaf}} = {\{ {x}_{i} ⊆ {C}_{CS}^{{t}_{leaf}} , {y}_{i} \}}_{i = 1}^{{N}_{{t}_{leaf}}} ∈ {R}^{{N}_{{t}_{leaf}} \times t} , t ≪ ( {T}_{node} / 2 ) - 1 \qquad ( 13 )$$

Wherein, D^{t}^{_{leaf}} represents the training data of T-S fuzzy inference, that is, the t_{leaf}-th nodes; xᵢ⊆C_{CS}^{t}^{_{leaf}} represents the t_{leaf}-th input features of C_{CS}^{t}^{_{leaf}}; yᵢ is the i-th true value; Nₜ_{_{leaf}} represents the number of sample in t_{leaf}-th nodes; t represents the number of sample features.

In fuzzy inference layer, K fuzzy rules are defined to represent the local linear relationship between the input feature and the target, which is expressed as follows:

$${R}_{k} : if {δ}_{1} is {A}_{1}^{k} and … and {x}_{t} is {A}_{t}^{k} then {y}_{k} = {g}^{k} ( {x}_{1} , … , {x}_{t} ) \qquad ( 14 )$$

Wherein, Rₖ represents:yₖ=g^{k}(x₁, . . . ,xₜ) when δ₁ is A₁^{k}, and . . . and xₜ is Aₜ^{k}.

The simplified form is:

$${R}_{k} : if {x}_{1}^{{t}_{leaf}} is {μ}_{{A}_{1}^{k}}^{k} ( {x}_{1}^{{t}_{leaf}} ) and … and {x}_{t}^{{t}_{leaf}} is \\ {μ}_{{A}_{t}^{k}}^{k} ( {x}_{t}^{{t}_{leaf}} ) then {y}_{k} = {g}^{k} ( {x}_{1} , … , {x}_{t} ) \qquad ( 15 )$$

Wherein, Rₖ represents: yₖ=g^{k}(x₁, . . . , xₜ) when xᵢ^{t}^{_{leaf}} is PA (x₁) and . . . and Xₜ^{t}^{_{leaf}} is μ_{A}_{ₜ}_{^{k}}^{k}(xₜ^{t}^{_{leaf}}); x₁^{t}^{_{leaf}} is the feature of the t_{leaf}-th clear set C_{CS}^{t}^{_{leaf}}, μ_{A}_{₁}_{^{k}}^{k}(·) is the membership function of A₁^{k}, μ_{A}_{₁}_{^{k}}^{k} (x₁^{t}^{_{leaf}}) represents the degree of membership of x₁^{t}^{_{leaf}}to A₁^{k}.

Use Gaussian function as membership function μ_{A}_{₁}_{^{k}}^{k} (·), which is expressed as follows:

$${μ}_{{A}_{t}^{k}}^{k} ( {x}_{t}^{{t}_{leaf}} ) = exp [ - \frac{{‖ {x}_{t}^{{t}_{leaf}} - {c}_{t , k} ‖}^{2}}{{σ}_{t , k}^{2}} ] \qquad ( 16 )$$

Wherein, c_{t,k} and σ_{t,k} respectively represents the center and width of μ_{A}_{₁}_{^{k}}^{k} (·).

Therefore, the k-th fuzzy rule for the t-th input feature is computed as follows:

$${o}_{k} = {\prod }_{t = 1}^{t} {μ}_{{A}_{t}^{k}}^{k} ( {x}_{t}^{{t}_{leaf}} ) = {μ}_{{A}_{1}^{k}}^{k} ( {x}_{1}^{{t}_{leaf}} ) ⋀ {μ}_{{A}_{2}^{k}}^{k} ( {x}_{2}^{{t}_{leaf}} ) ⋀ … ⋀ {μ}_{{A}_{t}^{k}}^{k} ( {x}_{t}^{{t}_{leaf}} ) \qquad ( 17 )$$

Wherein, Oₖ represents product output of the k-th fuzzy rule

$${\prod }_{t = 1}^{t} {μ}_{{A}_{t}^{k}}^{k} ( {x}_{t}^{{t}_{leaf}} )$$

t=1
represents the Cartesian product.

On the basis of formula (3), proceed normalization of the output {oₖ}ᵢ₌₁^{K} of the Cartesian product, the weights of the antecedent parts are calculated as follows:

$${\overline{o}}_{k} = {o}_{k} / {\sum }_{i = 1}^{K} {o}_{k} \qquad ( 18 )$$

Wherein, ōₖ is the k-th weight of the antecedent part.

Therefore, the fuzzy rule output resulting from the combination of the antecedent and the consequent is expressed as:

$${ϕ}_{i} = \overline{{o}_{k}} {g}_{i}^{k} ( {x}_{1} , … , {x}_{t} ) = \overline{{o}_{k}} ( {ω}_{1} {x}_{1} + {ω}_{2} {x}_{2} + {ω}_{2} {x}_{2} + … + {ω}_{t} {x}_{t} ) \qquad ( 19 )$$

Wherein, gᵢ^{k}(x₁, . . . , xₜ) is the output of the i-th fuzzy rule consequent.

Finally, calculate the predicted values of DXN emission concentration of xᵢ by a linear combination of fuzzy rules are as follows:

$${\hat{y}}_{i} = {\sum }_{k = 1}^{K} \overline{{o}_{k}} {g}_{i}^{k} ( {x}_{i} ) = {\sum }_{k = 1}^{K} {o}_{k} ( {ω}_{1} {x}_{1} + {ω}_{2} {x}_{2} + … + {ω}_{t} {x}_{t} ) / {\sum }_{k = 1}^{K} {o}_{k} \qquad ( 20 )$$

Wherein, ŷᵢ is the predicted output of input xᵢ.

Therefore, the DXN emission concentration TSFRT model is simplified as follows:

$$\hat{y} = {f}_{TSFRT} ( ( X , K , {θ}_{leaf} , ω , c , σ ) ) \qquad ( 21 )$$

Wherein, f_{TSFRT}(·) represents the DXN emission concentration TSFRT model; θ_{leaf} is the minimum number of samples of hyperparameters; ω is the weight matrix of the consequent; c and σ are the center and width of the membership function, respectively; X is the input data; K is the number of fuzzy rules.

In most cases, prior knowledge and pre-fuzzification are usually used to set the parameters of the fuzzy system. However, it increases the modeling burden and is not conducive to the rapid construction of a soft-sensor model of DXN emission concentration in the MSWI process. To solve this problem, an update strategy is adopted to determine the parameters of T-S fuzzy inference.

Parameter update learning algorithm for DXN emission concentration TSFRT Model

4.2.1 Parameter identification of the T-S antecedent

For DXN emission concentration TSFRT model ƒ_{TSFRT}(·), first define the training squared error as follows:

$$E = \frac{1}{2} {‖ y - {f}_{TSFRT} ( X , K , {θ}_{leaf} , ω , c , σ ) ‖}^{2} \qquad ( 22 )$$

Wherein, E represents the squared difference of all samples; X, K and θ_{leaf} are the input of ƒ_{TSFRT} (·); ω, c, and σ represent parameters that need to be further identified in the modeling process.

As shown in formula (15), the parameter of the antecedent part is the center Cₜ and width σₜ. To achieve the expected performance, these parameters are confirmed on the basis of the training data D and updated using the gradient descent (GD) method.
1) Update sample by sample

The sample-by-sample update strategy for center c and width o is expressed as follows:

$${c}_{i + 1} = {c}_{i} - {η}_{c} ∇ {c}_{i} ( {E}_{i} ) \qquad ( 23 )$$

$${σ}_{i + 1} = {σ}_{i} - {η}_{b} ∇ {σ}_{i} ( {E}_{i} ) \qquad ( 24 )$$

Wherein, cᵢ₌₁ is the center update matrix of the i+1-th sample, σᵢ₌₁ is the width update matrix of the i+1-th sample, η_{c}, and η₀ are the learning rates for the center and width, respectively; ∇_{c}_{ᵢ} (Eᵢ) and ∇σᵢ (Eᵢ) represents the gradient of the center and width of the i-th sample, and the gradient of the center and width of the t-th input feature of the i-th sample ∇_{c}_{_{i,t}}(Eᵢ) and ∇σ_{i,t} (Eᵢ) is calculated as follows:

$$∇ {c}_{i , t} ( {E}_{i} ) = {e}_{i} \frac{\partial {\hat{y}}_{i}}{\partial {c}_{i , t}} = {e}_{i} {g}_{i} ( {x}_{1} , … , {x}_{t} ) \frac{\partial {ϕ}_{i}}{\partial {c}_{i , t}} = {e}_{i} {g}_{i} ( {x}_{1} , … , {x}_{t} ) \frac{( \frac{\partial ( {\prod }_{t = 1}^{t} {μ}^{k} ( {x}_{t} ) )}{\partial {c}_{i , t}} ) {\sum }_{i = 1}^{K} {o}_{k} - ( \frac{\partial ( {\sum }_{i = 1}^{K} {o}_{k} )}{\partial {c}_{i , t}} ) {\prod }_{t = 1}^{t} {μ}^{k} ( {x}_{t} )}{{( {\sum }_{i = 1}^{K} {o}_{k} )}^{2}} = {e}_{i} {g}_{i} ( {x}_{1} , … , {x}_{t} ) \frac{\frac{\partial {μ}^{k} ( {x}_{t} )}{\partial {c}_{i , t}} {\sum }_{i = 1}^{K} {o}_{k} - \frac{\partial {μ}^{k} ( {x}_{t} )}{\partial {c}_{i , t}} {\prod }_{t = 1}^{t} {μ}^{k} ( {x}_{t} )}{{( {\sum }_{i = 1}^{K} {o}_{k} )}^{2}} = 2 {e}_{i} {g}_{i} ( {x}_{1} , … , {x}_{t} ) {μ}^{k} ( {x}_{t} ) ( {x}_{t} - {c}_{i , t} ) \frac{{\sum }_{i = 1}^{K} {o}_{k} - {\prod }_{t = 1}^{t} {μ}^{k} ( {x}_{t} )}{{{σ}_{i , t}^{2} ( {\sum }_{i = 1}^{K} {o}_{k} )}^{2}} \qquad ( 25 )$$

$$∇ {σ}_{i , t} ( {E}_{i} ) = {e}_{i} \frac{\partial {\hat{y}}_{i}}{\partial {σ}_{i , t}} = {e}_{i} {g}_{i} ( {x}_{1} , … , {x}_{t} ) \frac{\partial {ϕ}_{i}}{\partial {σ}_{i , t}} = {e}_{i} {g}_{i} ( {x}_{1} , … , {x}_{t} ) \frac{( \frac{\partial ( {\prod }_{t = 1}^{t} {μ}^{k} ( {x}_{t} ) )}{\partial {σ}_{i , t}} ) {\sum }_{i = 1}^{K} {o}_{k} - ( \frac{\partial ( {\sum }_{i = 1}^{K} {o}_{k} )}{\partial {σ}_{i , t}} ) {\prod }_{t = 1}^{t} {μ}^{k} ( {x}_{t} )}{{( {\sum }_{i = 1}^{K} {o}_{k} )}^{2}} = {e}_{i} {g}_{i} ( {x}_{1} , … , {x}_{t} ) \frac{\frac{\partial {μ}^{k} ( {x}_{t} )}{\partial {σ}_{i , t}} {\sum }_{i = 1}^{K} {o}_{k} - \frac{\partial {μ}^{k} ( {x}_{t} )}{\partial {σ}_{i , t}} {\prod }_{t = 1}^{t} {μ}^{k} ( {x}_{t} )}{{( {\sum }_{i = 1}^{K} {o}_{k} )}^{2}} = 2 {e}_{i} {g}_{i} ( {x}_{1} , … , {x}_{t} ) {μ}^{k} ( {x}_{t} ) {( {x}_{t} - {c}_{i , t} )}^{2} \frac{{\sum }_{i = 1}^{K} {o}_{k} - {\prod }_{t = 1}^{t} {μ}^{k} ( {x}_{t} )}{{{σ}_{i , t}^{3} ( {\sum }_{i = 1}^{K} {o}_{k} )}^{2}} \qquad ( 26 )$$

Wherein, Eᵢ is the squared error of the i-th sample; ŷᵢ is the i-th predicted value; ϕᵢ is fuzzy rule output obtained for the combination of antecedents and consequences; Oₖ is the product output of the k-th fuzzy rule; gᵢ(x₁, . . . ,xₜ) represents the fuzzy rule consequent output of the i-th sample; μₖ(xₜ) represents degree of membership of the k-th fuzzy rule to xₜ; c_{i,t} and σ_{i,t} are the center and width of the t-th input feature of the i-th sample, respectively; eᵢ represents error of the i-th sample, expressed as follows:

$${e}_{i} = {y}_{i} - {\hat{y}}_{i} = {y}_{i} - {\sum }_{k = 1}^{K} {\overline{o}}_{k} g ( {x}_{i} ) \qquad ( 27 )$$

Therefore, the model is denoted as the DXN emission concentration TSFRT-I model.

2) Batch sample update

The batch sample update strategy is based on batch GD (batch GD, BGD), which can effectively reduce the training time of the DXN emission concentration TSFRT-I model. Batches Dₙ_{_{batch}}^{t}^{_{leaf}} identified from the training dataset D^{t}^{_{leaf}} is expressed as:

$${D}_{{n}_{batch}}^{{t}_{leaf}} = \{ {\{ {x}_{i}^{{t}_{leaf}} \}}_{i = 1}^{{n}_{batch}} ⊆ {D}^{{t}_{leaf}} , {n}_{batch} ≪ {N}_{{t}_{leaf}} \} \qquad ( 28 )$$

Wherein, n_{batch} is the number of samples in a batch, Nₜ_{_{leaf}} is the number of samples in t_{leaf}-th node.

The process that center matrix c and width matrix o in batches Dₙ_{_{batch}}^{t}^{_{leaf}} updating once can be expressed as follows:

$${c}_{i + 1} = {c}_{i} - \frac{{η}_{c}}{{n}_{batch}} {\sum }_{{x}_{i} ∈ {D}_{{n}_{batch}}^{{t}_{leaf}}} ∇ {c}_{i} ( {E}_{{n}_{batch}} ) \qquad ( 29 )$$

$${σ}_{i + 1} = {σ}_{i} - \frac{{η}_{w}}{{n}_{batch}} {\sum }_{{x}_{i} ∈ {D}_{{n}_{batch}}^{{t}_{leaf}}} ∇ {σ}_{i} ( {E}_{{n}_{batch}} ) \qquad ( 30 )$$

Wherein, ∇_{c}_{ᵢ}(Eₙ_{_{batch}}) and ∇σᵢ(Eₙ_{_{batch}}) represent the BGD in Dₙ_{_{batch}}^{t}^{_{leaf}} of center and width, respectively, which is calculated from a single sample.

Therefore, the model is denoted as the DXN emission concentration TSFRT-II model.

Parameter Identification of T-S consequent

Three different methods are provided to determine the weight of the T-S consequential.

1) Update sample by sample

In the DXN emission concentration TSFRT-I model, the GD method is used to identify the center and width. Likewise, GD is used to update the consequent weights, which are expressed as follows:

$${ω}_{i + 1} = {ω}_{i} - {η}_{w} ∇ {ω}_{i} ( {E}_{i} ) \qquad ( 31 )$$

Wherein, η_{W} is the learning rate of the consequent weight; ∇ωᵢ(Eᵢ) represents the gradient of the consequent weight of the i-th sample, the consequent weight of the t-th feature of the i-th sample ∇ω_{i,t}(Eᵢ) is calculated as follows:

$$∇ {ω}_{i , t} ( {E}_{i} ) = {e}_{i} {\overline{o}}_{i} \frac{\partial {g}_{i} ( {x}_{1} , … , {x}_{t} )}{\partial {ω}_{i , t}} = {e}_{i} \frac{{o}_{k}}{{\sum }_{i = 1}^{K} {o}_{k}} x \qquad ( 32 )$$

2) Least squares update

In general, the least squares method is used to express the linear relationship between input and output, and formula (19) is reformulated as follows:

$$\begin{matrix}{\hat{y}}_{i} = \frac{{ω}_{1} {o}_{1} {x}_{1}}{{\sum }_{k = 1}^{K} {o}_{k}} + \frac{{ω}_{2} {o}_{2} {x}_{2}}{{\sum }_{k = 1}^{K} {o}_{k}} + … + \frac{{ω}_{t} {o}_{t} {x}_{t}}{{\sum }_{k = 1}^{K} {o}_{k}} \\ = {ω}_{1} {\overline{o}}_{1} {x}_{1} + {ω}_{2} {\overline{o}}_{2} {x}_{2} + … + {ω}_{t} {\overline{o}}_{t} {x}_{t} \\ = ω {x}_{i}^{*}\end{matrix} \qquad ( 33 )$$

Wherein, xᵢ*=[ō₁x₁, ō₂x₂, . . . ,ōₜxₜ]∈R^{1×t}.

Given an input matrix X* and the output vector y, the weights of the T-S consequent parts are calculated as follows:

$$ω = {( {( {X}^{*} )}^{T} {X}^{*} )}^{- 1} {( {X}^{*} )}^{T} y \qquad ( 34 )$$

Wherein, the size of ω is t×1; X* is consist of Nₜ_{_{leaf}}-th Xᵢ*, the size of X* is Nₜ_{_{leaf}}×t, (X*)^{T} represents the transposition of X*.

The premise of using the least squares method to update the weights is that the Oₖ of the antecedent part has already obtained. The i-th vector of input matrix X* is xᵢ*, the i-th element of the vector y is yᵢ, the recursive calculation is as follow:

$${ω}_{t + 1} = {ω}_{i} + {{S}_{i + 1} ( {x}_{i + 1}^{*} )}^{T} ( {y}_{i} - {x}_{i + 1}^{*} {ω}_{i} ) \qquad ( 35 )$$

$${S}_{i + 1} = {S}_{i} - ( {{S}_{i} ( {x}_{i + 1}^{*} )}^{T} {x}_{i + 1}^{*} {S}_{i} ) / ( 1 + {( {x}_{i + 1}^{*} )}^{T} {S}_{i} {x}_{i + 1}^{*} ) \qquad ( 36 )$$

In the formula, the initial value of ω₀ is randomly given; S₀ can be initialized to S₀=αI, where α is any positive number and I is the identity matrix.

The size of weight ωᵢ in the result is the main difference between sample-by-sample and least-squares update methods. he size of sample-by-sample updated weights ωᵢ is equal to t the ruleset the number of {Rₖ}ₖ₌₁^{K}, indicating the size interval of ωᵢ is [1, +∞], and the specific value is determined by the number of fuzzy rules. The least squares update has a fixed weight size ωᵢ. It can be seen from formula (33) that the size of weight ωᵢ and number of fuzzy rules K are determined by the input matrix X* . Therefore, the fuzzy rules updated sample-by-sample are the hyperparameters of the pre-defined DXN emission concentration TSFRT model through expert knowledge or adaptive adjustment, and the least squares updated fuzzy rules are no longer the hyperparameters of the DXN emission concentration TSFRT model, but the coefficients matrix Sᵢ.

3) Weight initialization based on prior knowledge

The weights are initialized by formula (5) to further utilize the prior knowledge of the screening layer, the scheme is shown in FIG. 4.

According to formula (5), formula (8) and formula (9), the MSE loss function is reformulated as follows:

$$[ {μ}_{CS}^{t} ( {x}_{i} ) , {Ω}_{t} ] = {arg min}_{δ} [ {( ( y - {ϑ}_{t} ) {μ}_{CS}^{t} ( {x}_{i} ) )}^{2} + {( ( y - {ϑ}_{t} ) {μ}_{CS}^{t} ( {x}_{i} ) )}^{2} ] \qquad ( 37 )$$

Furthermore,

$$t ≪ ( \frac{T}{2} ) - 1$$

loss value Ω is obtained, and then initialize the weights for the normalized subsequent parts as follows:

$${\overline{Ω}}_{t} = {Ω}_{t} / {\sum }_{t = 1}^{t} {Ω}_{t} \qquad ( 38 )$$

Therefore, input of the t_{leaf}-th T-S fuzzy inference can be expressed as follows:

$${D}^{{t}_{leaf}} = \{ {X}^{{t}_{leaf}} ⊆ {C}_{CS}^{{t}_{leaf}} , {y}^{{t}_{leaf}} , {\{ {\overline{Ω}}_{t} \}}_{t = 1}^{t} \} ∈ {ℝ}^{{N}_{{t}_{leaf}} \times t} \qquad ( 39 )$$

Wherein, {Ω̅ₜ}ₜ₌₁^{t} represents the initial weight ω₀. then, the final weights are obtained by recursively calculating formulas (34) and (35).

It should be pointed out that: for the DXN emission concentration TSFRT model, various parameter update strategies of sample-by-sample and BGD strategies are provided in the antecedent part; the weight-by-sample update, least squares update and prior knowledge are used to initialize the weight strategy in the consequent part. Therefore, a total of 5 types of DXN emission concentration TSFRT models with different antecedent and consequent partial identification methods are as follows:
TSFRT-J: the antecedent part is updated sample by sample, the consequent part is updated sample by sample, and the parameters are initialized randomly.
TSFRT-II: GBD update for the antecedent part, least squares update for the consequent part, and the number of samples n_{batch} in a batch is equal to the number of samples in t_{leaf}-th leaf nodes, parameters are initialized randomly.
TSFRT-III: This method is the same as the TSFRT-II model, but the consequent weights are initialized by prior knowledge.
TSFRT-IV: This method is the same as the TSFRT-II model, but the number of samples n_{batch} in a batch is equal to the number of samples Nₜ_{_{leaf}} in t_{1eaf}-th leaf nodes.
TSFRT-V: This method is the same as the TSFRT-IV model, except that the consequent weights are initialized by prior knowledge.

The above five types of DXN emission concentration TSFRT models are only updated in different ways, and can be selected arbitrarily according to needs.

4.3 DXN emission concentration integrated TSFRT (EnTSFRT)

An integrated modeling method of DXN emission concentration based on the TSFRT-III model is proposed, namely the DXN emission concentration EnTSFRT model, its structure is shown in FIG. 5.

In FIG. 5, the structure of the DXN emission concentration EnTSFRT is the same as that of the normal parallel integration method. However, the difference between this structure and random forest (RF) is that Bootstrap and random subspace methods are not adopted in EnTSFRT, and the pseudo-inverse method is adopted for the parallel ensemble output.

The modeling process of DXN emission concentration EnTSFRT is as follows:

First, given input X∈R^{N×M}, N and M are the number of samples and the number of features, respectively. Converting the DXN emission concentration to the output of the TSFRT-III model f_{TSFRT-III} ^{j}(·) represented as aⱼ∈R^{N×1} Therefore, the output of J -th DXN emission concentrations TSFRT-III model {f_{TSFRT-III} ^{j}(·)}ⱼ₌₁^{J} can be expressed as a matrix A∈R^{N×J}

Then, the pseudo-inverse is computed by employing the following optimization problem to estimate the weights with the smallest training error.

$${arg min}_{{W}_{LSM}^{J}} : {‖ {AW}_{LSM}^{J} - y ‖}^{2} + λ {‖ {W}_{LSM}^{J} ‖}^{2} \qquad ( 40 )$$

Wherein, W_{LSM}^{J}s is the weighted sum of squares constraint, A is any given constraint coefficient in (0, 1); y is the sample output.

The above optimal result is calculated by using the Moore-Penrose inverse matrix to calculate the weight matrix, as follows:

When the number J of DXN emission concentration TSFRT-III models is greater than the number of samples N, the weight W_{LSM}^{J}, is expressed as:

$${W}_{L S M}^{J} = {( {A}^{T} A + λ I )}^{1} {A}^{T} y \qquad ( 41 )$$

When the number J of DXN emission concentration TSFRT-III models is smaller than the number of samples N, the weight W_{LSM}^{J} is expressed as:

$${W}_{L S M}^{J} = {{A}^{T} ( λ I + A {4}^{T} )}^{1} y \qquad ( 42 )$$

Finally, the output of the DXN emission concentration EnTSFRT model is:

$$\hat{y} = A {W}_{L S M}^{J} = {[ {f}_{T S F R T}^{j} ( X ) ]}_{j = 1}^{J} {W}_{L S M}^{J} . \qquad ( 43 )$$

### DESCRIPTION OF THE DRAWINGS

FIG. 1 is the process flow chart of urban solid waste incineration process;

FIG. 2 is the BDT structure diagram;

FIG. 3 is the TSFRT structure diagram;

FIG. 4 is the weight initialization scheme based on prior knowledge;

FIG. 5 is the EnTSFRT structure diagram;

FIG. 6 is the fitting curves of different methods.

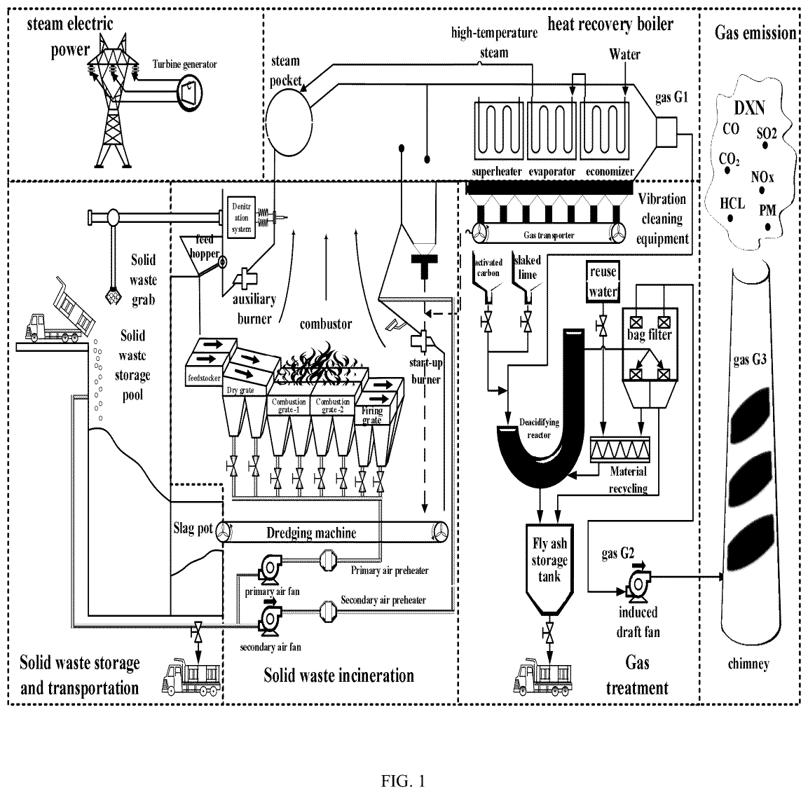

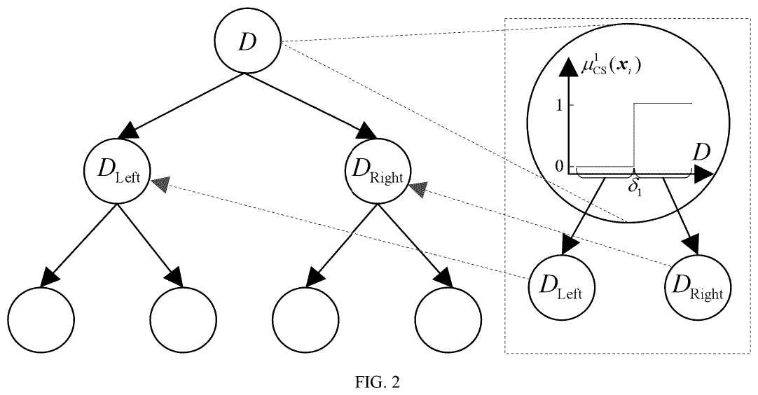

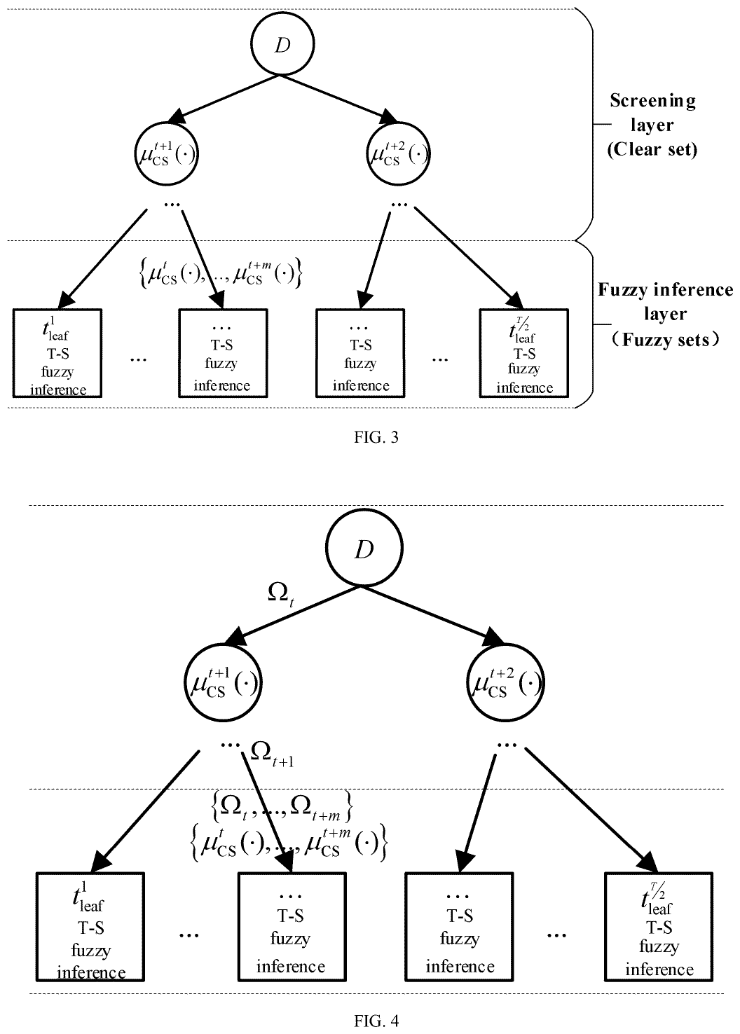

### SPECIFIC IMPLEMENTATIONS

The embodiment uses the actual DXN data of an MSWI power plant for industrial verification. The DXN data comes from a MSWI incineration power plant in Beijing. The data in this embodiment covers a total of 141 groups of DXN emission concentration detection samples from 2009 to 2020. The true value of DXN is the converted concentration after 2 hours of flue gas sampling and testing. The process data after removing the missing and abnormal variables in the DXN is 116-dimensional, and the mean value of the process data in the current DXN true value sampling time period is used as the input feature.

Root mean square error (RMSE), the mean absolute error MAE and the coefficient of determination (R²) are used to compare the performance of different soft sensing methods, which are calculated as follows:

$$RMSE = \sqrt{{\sum }_{i = 1}^{N} {( {y}_{i} - {\hat{y}}_{i} )}^{2} / ( N - 1 )} \qquad ( 44 )$$

$$MAE = \frac{1}{N} {\sum }_{i = 1}^{N} \vert {\hat{y}}_{i} - {y}_{i} \vert \qquad ( 45 )$$

$${R}^{2} = 1 - {\sum }_{i = 1}^{N} {( {y}_{i} - {\hat{y}}_{i} )}^{2} / {\sum }_{i = 1}^{N} {( {y}_{i} - \overline{y} )}^{2} \qquad ( 46 )$$

Wherein, yᵢ represents the i-th true value, ŷᵢ represents the i-th predicted value, y̅ represents the average output value, and N represents the number of samples.

The TSFRT-I, TSFRT-II, TSFRT-III, TSFRT-IV, TSFRT-V and EnTSFRT models for DXN emission concentrations were compared with T-S fuzzy neural network (FNN), BDT and RF models.

During training, all DXN emission concentration TSFRT and EnTSFRT models were trained using t-norms. Generally, the fuzzy inference process in FDT is highly dependent on the initial conditions, especially the initial values of center and width. In this application, the initial random number generation methods of the DXN emission concentration TSFRT-J, TSFRT-II, TSFRT-IIJ, TSFRT-IV, TSFRT-V, EnTSFRT and FNN models are fixed, and the corresponding hyperparameters are shown in Table 1.

TABLE 1
Details of hyperparameters

| | | | | | | | | | the number | |
|---|---|---|---|---|---|---|---|---|---|---|
| | | | | | | | | | of features | |
| | | | | | | | | | randomly | |
| Method | | θ_{leaf} | η | K | generations | α | η_{batch} | J | selected | λ |
| BDTs | | 3 | / | / | / | / | / | / | / | / |
| FNN | | / | 0.002 | M × 2 | 500 | / | / | / | / | / |
| RF | | 3 | / | / | / | / | / | 100 | \sqrt{M} | / |
| Embodiments | TSFRT- I | 10 | 0.02 | 116 | 100 | / | / | / | / | / |
| | TSFRT- II | 10 | 20 | / | / | 1 | / | / | / | / |
| | TSFRT-III | 10 | 20 | / | / | 1 | / | / | / | / |
| | TSFRT-IV | 10 | 20 | / | / | 1 | 5 | / | / | / |
| | TSFRT-V | 10 | 20 | / | / | 1 | 5 | / | / | / |
| | EnTSFRT | 10 | 50 | / | / | 1 | / | 50 | / | 10 |

Record:
‘/’ Indicates that the method does not have hyperparameter;
‘M × 2’ represents twice the dimension of the data set;
‘\sqrt{M}’ represents the square root of the data set dimension.

The statistics of the experimental results are shown in Table 2 and Image 6.

TABLE 2
Statistical results of different methods

| | | Training set | | | Validation set | | | Test set | | | |
|---|---|---|---|---|---|---|---|---|---|---|---|
| Method | | RMSE | MAE | R2 | RMSE | MAE | R2 | RMSE | MAE | R2 | Time |
| BDTs | | 3.00E−03 | 1.71E−03 | 9.89E−01 | 2.89E−02 | 1.76E−02 | −3.07E−02 | 2.27E−02 | 1.57E−02 | 2.64E−01 | 2.4305E+00 |
| FNN | | 7.37E−03 | 5.50E−03 | 9.36E−01 | 2.21E−02 | 1.79E−02 | 3.96E−01 | 1.54E−02 | 1.31E−02 | 6.60E−01 | 1.6118E+02 |
| RF | | 1.15E−02 | 9.12E−03 | 8.44E−01 | 1.99E−02 | 1.48E−02 | 5.11E−01 | 1.73E−02 | 1.38E−02 | 5.70E−01 | 1.0196E+01 |
| Embodiments | TSFRT-I | 1.92E−02 | 1.48E−02 | 5.66E−01 | 2.15E−02 | 1.52E−02 | 4.30E−01 | 1.85E−02 | 1.51E−02 | 5.08E−01 | 2.9100E+00 |
| | TSFRT-II | 2.29E−02 | 1.89E−02 | 3.82E−01 | 2.70E−02 | 1.92E−02 | 1.00E−01 | 1.90E−02 | 1.63E−02 | 4.81E−01 | 1.8249E+00 |
| | TSFRT-III | 1.87E−02 | 1.63E−02 | 5.88E−01 | 2.19E−02 | 1.66E−02 | 4.08E−01 | 1.80E−02 | 1.52E−02 | 5.38E−01 | 1.9880E+00 |
| | TSFRT-IV | 2.48E−02 | 2.21E−02 | 2.78E−01 | 2.51E−02 | 1.96E−02 | 2.20E−01 | 1.99E−02 | 1.73E−02 | 4.31E−01 | 1.8194E+00 |
| | TSFRT-V | 1.99E−02 | 1.67E−02 | 5.32E−01 | 2.12E−02 | 1.57E−02 | 4.46E−01 | 1.88E−02 | 1.55E−02 | 4.96E−01 | 2.0205E+00 |
| | EnTSFRT | 1.49E−02 | 1.17E−02 | 7.39E−01 | 2.22E−02 | 1.51E−02 | 3.88E−01 | 1.51E−02 | 1.27E−02 | 6.74E−01 | 9.7351E+01 |

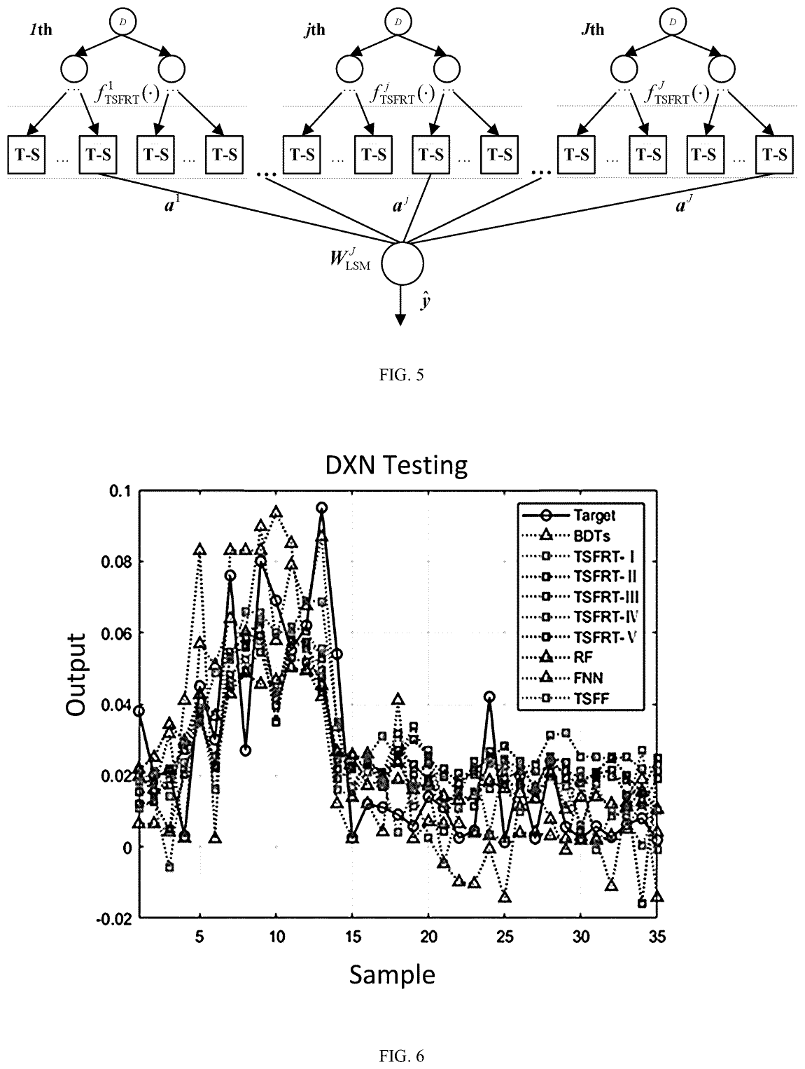

As shown in Table 2 and FIG. 6: (1) the proposed DXN emission concentration TSFRT model can effectively reduce the overfitting of BDT in the training set, and then improve the accuracy in the test set; (2) the training time of DXN emission concentration TSFRT-I is the longest in all DXN emission concentrations TSFRT methods, and the training time of other DXN emission concentration TSFRT methods is lower than BDT method; (3) The complex machine learning methods, such as FNN, RF and EnTSFRT, outperform the single learner on the DXN dataset. Among them, the DXN emission concentration EnTSFRT model performs the best, with much less fuzzy rules and shorter training time than the FNN method.

The results show that the DXN emission concentration EnTSFRT model proposed in this application has significant advantages and practical application potential compared with existing methods.

In the invention, a new EnTSFRT model for soft measurement of DXN emission concentration in MSWI process is proposed, which has a top-down structure, features screening through a growth process, T-S fuzzy inference for each leaf node, and multiple update strategies. The antecedent and consequent parameters are updated, and a pseudo-inverse-based model integration mechanism is used to improve the model generalization performance. The proposed method significantly outperforms other methods on real datasets.

What is claimed is:

1. A soft-sensing method for dioxin emissions of municipal solid waste incineration (MSWI) process based on ensemble T-S fuzzy regression tree, comprising:
for M input features x=[x₁ . . . xₘ . . . x_{M}]∈R^{1×M}, using K IF-THEN fuzzy rules to describe local linear relationship, a k-th fuzzy rule is expressed as:
$${R}_{k} : if {x}_{1} is {A}_{1}^{k} and … and {x}_{m} is {A}_{m}^{k} and … and {x}_{M} is {A}_{M}^{k} then \\ {ϕ}_{k} = {g}^{k} ( {x}_{1} , … , {x}_{M} ) \qquad ( 1 )$$
wherein Rₖ is: when xᵢ is A₁^{k} and . . . and xₘ is Aₘ^{k} and . . . and ϕₖ=g^{k} (x₁, . . . , x_{M}) when xₘ is Aₘ^{k}, A₁^{k}, Aₘ^{k} and A_{M}^{k} respectively represent fuzzy set specified by a membership function of x₁, xₘ and x_{M}; ϕₖ represents an output of the k-th fuzzy rule, g^{k} (x₁, . . . , x_{M}) is expressed as:
$${g}^{k} ( {x}_{1} , … , {x}_{M} ) = {ω}_{1} {x}_{1} + {ω}_{2} {x}_{2} + … + {ω}_{M} {x}_{M} \qquad ( 2 )$$
wherein ω₁, ω₂ and ωₘ are weight corresponding to x₁, x₂ and xₘ;
therefore, T-S fuzzy inference system f_{T-S}(x) based on K fuzzy rules {Rₖ}ₖ₌₁^{K} is expressed as follows:
$${f}_{T - S} ( x ) = \frac{{\sum }_{k = 1}^{K} ( {\prod }_{m = 1}^{M} {A}_{m}^{k} ) {ϕ}_{k}}{{\sum }_{k = 1}^{K} ( {\prod }_{m = 1}^{M} {A}_{m}^{k} )} = \frac{{\sum }_{k = 1}^{K} ( {\prod }_{m = 1}^{M} {A}_{m}^{k} ) {g}_{i}^{k} ( {x}_{1} , … , {x}_{M} )}{{\sum }_{k = 1}^{K} ( {\prod }_{m = 1}^{M} {A}_{m}^{k} )} \qquad ( 3 )$$
wherein
$${\prod }_{m = 1}^{M} {A}_{m}^{k}$$
represents a fuzzy operation between fuzzy set {A₁^{k}, . . . ,Aₘ^{k}, . . . ,A_{M}^{k}}, which usually use t-norms, s-norms or Cartesian product;
a Classification and Regression Trees (CART) algorithm in binary decision tree (BDT) is used for regression modeling; BDT constructed by a feature set (clear set) {μ_{CS} ¹(·) . . . μ_{CS}^{m}(·)}⊆{xᵢ}₁₌₁^{N} is a top-down recursive segmentation dataset;
to implement a top-down recursive process, clear set theory is applied in all non-leaf nodes; suppose that a BDT model is composed of T_{node} nodes; therefore, number of non-leaf nodes is T_{node}/2-1, and membership function of clear set is expressed as {μ_{CS}^{t}(·)}ₜ₌₁^{T}^{_{node}}^{/2-1}, a t-th membership function is expressed as follows:
$${μ}_{CS}^{t} ( {x}_{i} ) = \{ \begin{matrix}1 , & if {x}_{i , m} \geq {δ}_{t} \\ 0 , & if {x}_{i , m} < {δ}_{t}\end{matrix} , t = 1 , … , ( {T}_{n o d e} / 2 - 1 ) \qquad ( 4 )$$
wherein μ_{CS} (xᵢ) represents clear membership function of xᵢ, δₜ is segmentation node of the t-th membership function, determined by minimizing a mean square error (MSE), and a calculation process is as follows:
$$Ω = {arg min}_{{δ}_{t}} [ {f}_{M S B} ( {D}_{Left} ) + {f}_{M S B} ( {D}_{Right} ) ] = {arg min}_{{δ}_{t}} [ {( ( {y}_{Left} - {ϑ}_{t}^{Left} ) {μ}_{C S}^{t} ( {x}_{i} ) )}^{2} + {( ( {y}_{Right} - {ϑ}_{t}^{Right} ) {μ}_{C S}^{t} ( {x}_{i} ) )}^{2} ] \qquad ( 5 )$$
wherein Ω is loss value; ƒ_{MSE}(D_{Left}) and ƒ_{MSE} (D_{Right}) respectively represents MSE of left subset D_{Left} and right subset D_{Right}; ϑₜ^{Left} and ϑₜ^{Right} respectively represents true value vector of left subset D_{Left} and right subset D_{Right}; ϑₜ^{Left} and ϑₜ^{Right} respectively represents mean of target values of left subset D_{Left} and right subset D_{Right}:
$${ϑ}_{t}^{Left} = \frac{1}{{N}_{S u b s e t}^{Left}} {\sum }_{i = 1}^{{N}_{S u b s e t}^{Left}} {y}_{Left , i} \qquad ( 6 )$$
$${ϑ}_{t}^{Right} = \frac{1}{{N}_{S u b s e t}^{Right}} {\sum }_{i = 1}^{{N}_{S u b s e t}^{Right}} {y}_{Right , i} \qquad ( 7 )$$
wherein N_{Subset}^{Left} and N_{Subset}^{Right} respectively represents number of sample of left subset D_{Left}and right subset D_{Right}; Y_{Left,i} and γ_{Right,i} respectively represents i-th true value of y_{Left} and γ_{Right}
therefore, a BDT model can be expressed as:
$${f}_{C D T} ( x ) = {\sum }_{{t}_{leaf} = 1}^{T / 2} {ϑ}_{{t}_{leaf}} {\{ {μ}_{C S}^{t} ( {x}_{i} ) \}}_{t = 1}^{T / 2 - 1} \qquad ( 8 )$$
wherein ϑₜ_{_{leaf}} is mean value of t_{leaf}-th leaf nodes;
modeling of dioxin (DXN) emission concentration based on Integrated T-S fuzzy regression tree:
firstly, a structure of a DXN emission concentration TSFRT model is introduced; then, a learning algorithm of TSFRT model is provided; finally, a DXN emission concentration EnTSFRT model is proposed;
4.1 construction of DXN emission concentration TSFRT model:
DXN emission concentration TSFRT model comprises a screening layer (clear set) and a fuzzy inference layer (fuzzy set), whereinthe screening layer is used for feature screening, and the fuzzy inference layer is used for T-S fuzzy inference:
in screening layer, input is training dataset D={xᵢ,yᵢ}ᵢ₌₁^{N}∈R^{N×M+1}; first, each eigenvalue in dataset D is traversed and its MSE value is calculated using formula (5); then, a first degree of membership μ_{CS}¹(·) in clear set C_{CS}^{t}^{_{leaf}} is obtained by minimum MSE; therefore, dataset D is divided into two left and right subsets as follows:
$$\{ \begin{matrix}{D}_{Left} : \{ {D}_{Left} ∈ {R}^{{N}_{left} \times M} \vert {μ}_{C S}^{1} ( x ) ≡ 1 \} \\ {D}_{R i g h t} : \{ {D}_{R i g h t} ∈ {R}^{{N}_{Right} \times M} \vert {μ}_{C S}^{1} ( x ) ≡ 0 \}\end{matrix} \qquad ( 9 )$$
wherein {D_{Left} ∈ R^{N}^{_{Left}}^{×M}|μ_{CS}¹(x)≡1 represents that left subset D_{Le}f belongs to N_{Le}f xM real number space when μ_{CS}¹(x)≡1, {D_{Right} ∈R^{N}^{_{Right}} ^{×M}|μ_{CS}¹(x)≡0} represents that right subset D_{Right} belongs to N_{Right}×M real number space when μ_{CS}¹(x)≡0;
a first element (δ₁=x_{i,m}) in C_{CS}^{t}^{_{leaf}} is determined by formula (4), expressed as follows:
$${C}_{CS}^{{t}_{leaf}} : \{ {μ}_{CS}^{1} ( x ) \} \qquad ( 10 )$$
repeating the above process, the DXN emission concentration TSFRT model exists T_{node}/2-1 internal nodes; therefore, T_{node}/2 subsets {D_{subset}^{t}}ₜ₌₁^{T}^{_{node}}^{/2} is generated; a t_{leaf} clear set {CCStleaf}ₜ_{_{leaf}}₌₁^{T}^{_{node}}^{/2} is expressed as:
$${C}_{CS}^{{t}_{leaf}} : \{ {μ}_{CS}^{1} ( x ) , … , {μ}_{CS}^{t} ( x ) \vert t ≪ ( {T}_{node} / 2 ) - 1 \} \qquad ( 11 )$$
a simplified form is:
$${C}_{CS}^{{t}_{leaf}} : \{ {δ}_{1} , … , {δ}_{t} \vert t ≪ ( {T}_{node} / 2 ) - 1 \} \qquad ( 12 )$$
therefore, an input representation of a resulting T-S fuzzy inference of the t_{leaf}-th clear set {C_{CS}^{t}^{_{leaf}}}ₜ_{_{leaf}}₌₁^{T}^{_{node}}^{/2} is as follows:
$${D}^{{t}_{leaf}} = {\{ {x}_{i} ⊆ {C}_{CS}^{{t}_{leaf}} , {y}_{i} \}}_{i = 1}^{{N}_{{t}_{leaf}}} ∈ {R}^{{N}_{{t}_{leaf}} \times t} , t ≪ ( {T}_{node} / 2 ) - 1 \qquad ( 13 )$$
wherein D^{t}^{_{leaf}}represents training data of T-S fuzzy inference, that is, the t_{leaf}-th nodes; xᵢ⊆C_{CS}^{t}^{_{leaf}} represents t_{leaf}-th input features of C_{CS}^{t}^{_{leaf}}; γᵢ is the i-th true value; Nₜ_{_{leaf}}represents the number of sample in t_{leaf}-th nodes; t represents the number of sample features;
in fuzzy inference layer, K fuzzy rules are defined to represent a local linear relationship between the input feature and the target, which is expressed as follows:
$${R}_{k} : if {δ}_{1} is {A}_{1}^{k} and … and {x}_{t} is {A}_{t}^{k} then {y}_{k} = {g}^{k} ( {x}_{1} , … , {x}_{t} ) \qquad ( 14 )$$
wherein Rₖ represents:γₖ=g^{k}(x₁, . . . ,xᵢ) when δ₁ is A₁^{k}, and . . . and Xₜ is Aₜ^{k};
a simplified form is:
$${R}_{k} : if {x}_{1}^{{t}_{leaf}} is {μ}_{{A}_{1}^{k}}^{k} ( {x}_{1}^{{t}_{leaf}} ) and … and {x}_{t}^{{t}_{leaf}} is \qquad ( 15 )$$
$${μ}_{{A}_{t}^{k}}^{k} ( {x}_{t}^{{t}_{leaf}} ) then {y}_{k} = {g}^{k} ( {x}_{1} , … , {x}_{t} )$$
wherein Rₖ represents: γₖ=g^{k}(x₁, . . . , xₜ) when x₁^{t}^{_{leaf}} is μ_{A}_{₁}ₖ^{k}(x₁^{t}^{_{leaf}}) and . . . and Xₜ^{t}^{_{leaf}} is μ_{A}_{₁}ₖ^{k} (xₜ^{t}^{_{leaf}}); x₁ ^{t}^{_{leaf}} is feature of the t_{leaf}-th clear set C_{CS}^{t}^{_{leaf}}, μ_{A}_{₁}ₖ^{k}(·) is membership function of A₁^{k}, μ_{A}_{₁}ₖ^{k}(x₁^{t}^{_{leaf}}) represents degree of membership of x₁^{t}^{_{leaf}}to A₁^{k};
use Gaussian function as membership function μ_{A}_{₁}ₖ^{k}(·), which is expressed as follows:
$${μ}_{{A}_{t}^{k}}^{k} ( {x}_{t}^{{t}_{leaf}} ) = exp [ - \frac{{‖ {x}_{t}^{{t}_{leaf}} - {c}_{t , k} ‖}^{2}}{{σ}_{t , k}^{2}} ] \qquad ( 16 )$$
wherein c_{t,k} and σ_{t,k} respectively represents center and width of μ_{A}_{₁}ₖ^{k}(·);
therefore, a k-th fuzzy rule for t-th input feature is computed as follows:
$${o}_{k} = {\prod }_{t = 1}^{t} {μ}_{{A}_{t}^{k}}^{k} ( {x}_{t}^{{t}_{leaf}} ) = {μ}_{{A}_{1}^{k}}^{k} ( {x}_{1}^{{t}_{leaf}} ) ⋀ {μ}_{{A}_{2}^{k}}^{k} ( {x}_{2}^{{t}_{leaf}} ) ⋀ … ⋀ {μ}_{{A}_{t}^{k}}^{k} ( {x}_{t}^{{t}_{leaf}} ) \qquad ( 17 )$$
wherein Oₖ represents product output of the k-th fuzzy rule,
$${\prod }_{t = 1}^{t} {μ}_{{A}_{t}^{k}}^{k} ( {x}_{t}^{{t}_{leaf}} )$$
represents the Cartesian product;
based on formula (3), proceed normalization of an output {Oₖ}ᵢ₌₁^{K} of the Cartesian product, weights of antecedent parts are calculated as follows:
$${\overline{o}}_{k} = {o}_{k} / {\sum }_{i = 1}^{K} {o}_{k} \qquad ( 18 )$$
wherein ōₖ is a k-th weight of the antecedent part;
therefore, a fuzzy rule output resulting from a combination of an antecedent and a consequent is expressed as:
$${ϕ}_{i} = {\overline{o}}_{k} {g}_{i}^{k} ( {x}_{1} , … , {x}_{t} ) = {\overline{o}}_{k} ( {ω}_{1} {x}_{1} + {ω}_{2} {x}_{2} + … + {ω}_{t} {x}_{t} ) \qquad ( 19 )$$
wherein gᵢ^{k}(X₁, . . . , xₜ) is an output of an i-th fuzzy rule consequent;
finally, calculate a predicted values of DXN emission concentration of xᵢ by a linear combination of fuzzy rules are as follows:
$${\hat{y}}_{i} = {\sum }_{k = 1}^{K} {\overline{o}}_{k} {g}_{i}^{k} ( {x}_{i} ) = {\sum }_{k = 1}^{K} {o}_{k} ( {ω}_{1} {x}_{1} + {ω}_{2} {x}_{2} + … + {ω}_{t} {x}_{t} ) / {\sum }_{k = 1}^{K} {o}_{k} \qquad ( 20 )$$
wherein ŷᵢ is a predicted output of input xᵢ;
therefore, the DXN emission concentration TSFRT model is simplified as follows:
$$\hat{y} = {f}_{TSFRT} ( ( X , K , {θ}_{leaf} , ω , c , σ ) ) \qquad ( 21 )$$
wherein ƒ_{TSFRT}(·) represents the DXN emission concentration TSFRT model; θ_{leaf} is minimum number of samples of hyperparameters; ω is weight matrix of the consequent; c and σ are center and width of the membership function, respectively; X is input data; K is number of fuzzy rules;
in most cases, prior knowledge and pre-fuzzification are usually used to set parameters of a fuzzy system; however, it increases a modeling burden and is not conducive to a rapid construction of a soft-sensor model of DXN emission concentration in the MSWI process; to solve this problem, an update strategy is adopted to determine parameters of T-S fuzzy inference;
parameter update learning algorithmfor the DXN emission concentration TSFRT Model
parameter identification of a T-S antecedent
for the DXN emission concentration TSFRT model ƒTSFRT(·), first define a training squared error as follows:
$$E = \frac{1}{2} {‖ y - {f}_{TSFRT} ( X , K , {θ}_{leaf} , ω , c , σ ) ‖}^{2} \qquad ( 22 )$$
wherein E represents squared difference of all samples; X, K and θ_{leaf} are input of ƒ_{TSFRT}(·); ω, c, and σ represent parameters that need to be further identified in modeling process;
as shown in formula (15), parameter of the antecedent part is center c, and width σₜ; to achieve expected performance, these parameters are confirmed based on a training data D and updated using a gradient descent (GD) method;
1) update sample by sample
the sample-by-sample update strategy for center c and width σ is expressed as follows:
$${c}_{i + 1} = {c}_{i} - {η}_{c} ∇ {c}_{i} ( {E}_{i} ) \qquad ( 23 )$$
$${σ}_{i + 1} = {σ}_{i} - {η}_{b} ∇ {σ}_{i} ( {E}_{i} ) \qquad ( 24 )$$
wherein cᵢ₊₁ is center update matrix of i+1-th sample, σᵢ₊₁ is width update matrix of i+1-th sample, η_{c} and η₀ are learning rates for center and width, respectively; ∇cᵢ (Eᵢ) and ∇σᵢ (Eᵢ) represents gradient of center and width of i-th sample, and the gradient of the center and width of a t-th input feature of the i-th sample ∇c_{i,t}(Eᵢ) and ∇σ_{i,t} (Eᵢ) is calculated as follows:
$$\begin{matrix}∇ {c}_{i , t} ( {E}_{i} ) = {e}_{i} \frac{\partial {\hat{y}}_{i}}{\partial {c}_{i , t}} = {e}_{i} {g}_{i} ( {x}_{1} , … , {x}_{t} ) \frac{\partial {ϕ}_{i}}{\partial {c}_{i , t}} \\ = {e}_{i} {g}_{i} ( {x}_{1} , … , {x}_{t} ) \\ \frac{( \frac{\partial ( {\prod }_{t = 1}^{t} {μ}^{k} ( {x}_{t} ) )}{\partial {c}_{i , t}} ) {\sum }_{i = 1}^{K} {o}_{k} - ( \frac{\partial ( {\sum }_{i = 1}^{K} {o}_{k} )}{\partial {c}_{i , t}} ) {\prod }_{t = 1}^{t} {μ}^{k} ( {x}_{t} )}{{( {\sum }_{i = 1}^{K} {o}_{k} )}^{2}} \\ = {e}_{i} {g}_{i} ( {x}_{1} , … , {x}_{t} ) \frac{\frac{\partial {μ}^{k} ( {x}_{t} )}{\partial {c}_{i , t}} {\sum }_{i = 1}^{K} {o}_{k} - \frac{\partial {μ}^{k} ( {x}_{t} )}{\partial {c}_{i , t}} {\prod }_{t = 1}^{t} {μ}^{k} ( {x}_{t} )}{{( {\sum }_{i = 1}^{K} {o}_{k} )}^{2}} \\ = 2 {e}_{i} {g}_{i} ( {x}_{1} , … , {x}_{t} ) {μ}^{k} ( {x}_{t} ) ( {x}_{t} - {c}_{i , t} ) \frac{{\sum }_{i = 1}^{K} {o}_{k} - {\prod }_{t = 1}^{t} {μ}^{k} ( {x}_{t} )}{{{σ}_{i , t}^{2} ( {\sum }_{i = 1}^{K} {o}_{k} )}^{2}}\end{matrix} \qquad ( 25 )$$
$$\begin{matrix}∇ {σ}_{i , t} ( {E}_{i} ) = {e}_{i} \frac{\partial {\hat{y}}_{i}}{\partial {σ}_{i , t}} = {e}_{i} {g}_{i} ( {x}_{1} , … , {x}_{t} ) \frac{\partial {ϕ}_{i}}{\partial {σ}_{i , t}} \\ = {e}_{i} {g}_{i} ( {x}_{1} , … , {x}_{t} ) \\ \frac{( \frac{\partial ( {\prod }_{t = 1}^{t} {μ}^{k} ( {x}_{t} ) )}{\partial {σ}_{i , t}} ) {\sum }_{i = 1}^{K} {o}_{k} - ( \frac{\partial ( {\sum }_{i = 1}^{K} {o}_{k} )}{\partial {σ}_{i , t}} ) {\prod }_{t = 1}^{t} {μ}^{k} ( {x}_{t} )}{{( {\sum }_{i = 1}^{K} {o}_{k} )}^{2}} \\ = {e}_{i} {g}_{i} ( {x}_{1} , … , {x}_{t} ) \frac{\frac{\partial {μ}^{k} ( {x}_{t} )}{\partial {σ}_{i , t}} {\sum }_{i = 1}^{K} {o}_{k} - \frac{\partial {μ}^{k} ( {x}_{t} )}{\partial {σ}_{i , t}} {\prod }_{t = 1}^{t} {μ}^{k} ( {x}_{t} )}{{( {\sum }_{i = 1}^{K} {o}_{k} )}^{2}} \\ = 2 {e}_{i} {g}_{i} ( {x}_{1} , … , {x}_{t} ) {μ}^{k} ( {x}_{t} ) {( {x}_{t} - {c}_{i , t} )}^{2} \frac{{\sum }_{i = 1}^{K} {o}_{k} - {\prod }_{t = 1}^{t} {μ}^{k} ( {x}_{t} )}{{{σ}_{i , t}^{3} ( {\sum }_{i = 1}^{K} {o}_{k} )}^{2}}\end{matrix} \qquad ( 26 )$$
wherein Eᵢ is squared error of the i-th sample; ŷᵢ is i-th predicted value; ϕᵢ is fuzzy rule output obtained for the combination of antecedents and consequences; Oₖ is product output of the k-th fuzzy rule; gᵢ(xᵢ, . . . ,xₜ) represents a fuzzy rule consequent output of the i-th sample; μ^{k}(Xₜ) represents degree of membership of the k-th fuzzy rule to xₜ; c_{i,t} and σ_{i,j} are the center and width of the t-th input feature of the i-th sample, respectively; eᵢ represents error of the i-th sample, expressed as follows:
$${e}_{i} = {y}_{i} - {\hat{y}}_{i} = {y}_{i} - {\sum }_{k = 1}^{K} {\overline{o}}_{k} g ( {x}_{i} ) \qquad ( 27 )$$
therefore, a model is denoted as a DXN emission concentration TSFRT-I model;
2) batch sample update
a batch sample update strategy is based on batch GD (batch GD, BGD), which can effectively reduce training time of the DXN emission concentration TSFRT-I model; batches
Dₙ_{_{batch}}^{t}^{_{leaf}} identified from the training dataset D^{t}^{_{leaf}} is expressed as:
$${D}_{{n}_{batch}}^{{t}_{leaf}} = \{ {\{ {x}_{i}^{{t}_{leaf}} \}}_{i = 1}^{{n}_{batch}} ⊆ {D}^{{t}_{leaf}} , {n}_{batch} << {N}_{{t}_{leaf}} \} \qquad ( 28 )$$
wherein n_{batch} is the number of samples in a batch, Nₜ_{_{leaf}} is the number of samples in t_{leaf}-th node;
a process that center matrix c and width matrix σ in batches Dₙ_{_{batch}}^{t}^{_{leaf}} updating once can be expressed as follows:
$${C}_{i + 1} = {C}_{i} - \frac{{η}_{c}}{{n}_{batch}} {\sum }_{{x}_{i} ∈ {D}_{{n}_{batch}}^{{t}_{leaf}}} ∇ {c}_{i} ( {E}_{{n}_{batch}} ) \qquad ( 29 )$$
$${σ}_{i + 1} = {σ}_{i} - \frac{{η}_{w}}{{n}_{b a t c h}} {\sum }_{{x}_{i} ∈ {D}_{{n}_{batch}}^{{t}_{leaf}}} ∇ {σ}_{i} ( {E}_{{n}_{batch}} ) \qquad ( 30 )$$
wherein ∇cᵢ(Eₙ_{_{batch}}) and ∇σᵢ (Eₙ_{_{batch}} represent BGD in Dₙ_{_{batch}} ^{t}^{_{leaf}} of center and width, respectively, which is calculated from a single sample;
therefore, a model is denoted as a DXN emission concentration TSFRT-II mode;
parameter identification of T-S consequent
three different methods are provided to determine the weight of the T-S consequential;
1) Update sample by sample
in the DXN emission concentration TSFRT-I model, the GD method is used to identify the center and width; likewise, GD is used to update consequent weights, which are expressed as follows:
$${ω}_{i + 1} = {ω}_{i} - {η}_{w} ∇ {ω}_{i} ( {E}_{i} ) \qquad ( 31 )$$
wherein η_{W} is the learning rate of a consequent weight; ∇ωᵢ(Eᵢ) represents gradient of consequent weight of the i-th sample, the consequent weight of a t-th feature of the i-th sample ∇ω_{i,t}(Eᵢ) is calculated as follows:
$$Δ {ω}_{i , t} ( {E}_{i} ) = {e}_{i} {\overline{o}}_{i} \frac{\partial {g}_{i} ( {x}_{1} , … , {x}_{t} )}{\partial {ω}_{i , t}} = {e}_{i} \frac{{o}_{k}}{{\sum }_{i = 1}^{K} {o}_{k}} x \qquad ( 32 )$$
2) least squares update
in general, a least squares method is used to express a linear relationship between input and output, and formula (19) is reformulated as follows:
$$\begin{matrix}{\hat{y}}_{i} = \frac{{ω}_{1} {o}_{1} {x}_{1}}{{\sum }_{k = 1}^{K} {o}_{k}} + \frac{{ω}_{2} {o}_{2} {x}_{2}}{{\sum }_{k = 1}^{K} {o}_{k}} + … + \frac{{ω}_{t} {o}_{t} {x}_{t}}{{\sum }_{k = 1}^{K} {o}_{k}} \\ = {ω}_{1} {\overline{o}}_{1} {x}_{1} + {ω}_{2} {\overline{o}}_{2} {x}_{2} + … + {ω}_{t} {\overline{o}}_{t} {x}_{t} \\ = ω {x}_{i}^{*}\end{matrix} \qquad ( 33 )$$
wherein Xᵢ*=[ō₁X₁,ō₂, . . . ōₜxₜ]∈R^{1×t}
given an input matrix X* and an output vector y, weights of T-S consequent parts are calculated as follows:
$$ω = {( {( {X}^{*} )}^{T} {X}^{*} )}^{- 1} {( {X}^{*} )}^{T} y \qquad ( 34 )$$
wherein a size of ω is t×1; X* is consist of Nₜ_{_{leaf}}-th Xᵢ*, a size of X* is Nₜ_{_{leaf}}×t, (X*)^{T} represents the transposition of X*;
a premise of using the least squares method to update the weights is that Oₖ of the antecedent part has already obtained; an i-th vector of input matrix X* is xᵢ*, an i-th element of the vector y is γᵢ, a recursive calculation is as follow:
$${ω}_{t + 1} = {ω}_{i} + {{S}_{i + 1} ( {x}_{i + 1}^{*} )}^{T} ( {y}_{i} - {x}_{i + 1}^{*} {ω}_{i} ) \qquad ( 35 )$$
$${S}_{i + 1} = {S}_{i} - ( {{S}_{i} ( {x}_{i + 1}^{*} )}^{T} {x}_{i + 1}^{*} {S}_{i} ) / ( 1 + {( {x}_{i + 1}^{*} )}^{T} {S}_{i} {x}_{i + 1}^{*} ) \qquad ( 36 )$$
in the formula, initial value of ω₀ is randomly given; S₀ can be initialized to S₀≡αI, where α is any positive number and I is an identity matrix;
the size of weight ωᵢ in result is a main difference between sample-by-sample and least-squares update methods; the size of sample-by-sample updated weights ωᵢ is equal to the ruleset the number of {Rₖ}ₖ₌₁^{K}, indicating size interval of ωᵢ is [1, +∞], and a specific value is determined by the number of fuzzy rules; the least squares update has a fixed weight size ωᵢ; it can be seen from formula (33) that the size of weight ωᵢ and number of fuzzy rules K are determined by the input matrix X*; therefore, the fuzzy rules updated sample-by-sample are the hyperparameters of a pre-defined DXN emission concentration TSFRT model through expert knowledge or adaptive adjustment, and least squares updated fuzzy rules are no longer the hyperparameters of the DXN emission concentration TSFRT model, but a coefficients matrix Sᵢ;
3) weight initialization based on prior knowledge
the weights are initialized by formula (5) to further utilize the prior knowledge of the screening layer;
according to formula (5), formula (8) and formula (9), MSE loss function is reformulated as follows:
$$[ {μ}_{CS}^{t} ( {x}_{i} ) , {Ω}_{t} ] = {arg min}_{δ} [ {( ( y - {ϑ}_{t} ) {μ}_{CS}^{t} ( {x}_{i} ) )}^{2} + {( ( y - {ϑ}_{t} ) {μ}_{CS}^{t} ( {x}_{i} ) )}^{2} ] \qquad ( 37 )$$
furthermore,
$$t << ( \frac{T}{2} ) - 1$$
loss value Ω is obtained, and then initialize the weights for normalized subsequent parts as follows:
$${\overline{Ω}}_{t} = {Ω}_{t} / {\sum }_{t = 1}^{t} {Ω}_{t} \qquad ( 38 )$$
therefore, input of the t_{leaf}-th T-S fuzzy inference can be expressed as follows:
$${D}^{{t}_{leaf}} = \{ {X}^{{t}_{leaf}} ⊆ {C}_{CS}^{{t}_{leaf}} , {y}^{{t}_{leaf}} , {\{ {\overline{Ω}}_{t} \}}_{t = 1}^{t} \} ∈ {ℝ}^{{N}_{{t}_{leaf}} \times t} \qquad ( 39 )$$
wherein {Ω̅ₜ}ₜ₌₁^{t} represents an initial weight ω₀; then, final weights are obtained by recursively calculating formulas (34) and (35);
it should be pointed out that: for the DXN emission concentration TSFRT model, various parameter update strategies of sample-by-sample and BGD strategies are provided in the antecedent part; a weight-by-sample update, least squares update and prior knowledge are used to initialize a weight strategy in the consequent part; therefore, a total of 5 types of DXN emission concentration TSFRT models with different antecedent and consequent partial identification methods are as follows:
TSFRT-I: the antecedent part is updated sample by sample, the consequent part is updated sample by sample, and the parameters are initialized randomly;
TSFRT-II: GBD update for the antecedent part, least squares update for the consequent part, and the number of samples n_{batch} in a batch is equal to the number of samples in t_{leaf}-th leaf nodes, parameters are initialized randomly;
TSFRT-III: this method is the same as the TSFRT-II model, but the consequent weights are initialized by prior knowledge;
TSFRT-IV: this method is the same as the TSFRT-II model, but the number of samples nbatcₕ in a batch is equal to the number of samples Nₜ_{_{leaf}} in t_{leaf}-th leaf nodes;
TSFRT-V: this method is the same as the TSFRT-IV model, except that the consequent weights are initialized by prior knowledge;
the above five types of DXN emission concentration TSFRT models are only updated in different ways, and can be selected arbitrarily according to needs;
an integrated modeling method of DXN emission concentration based on the TSFRT-III model is proposed, namely the DXN emission concentration EnTSFRT model;
a modeling process of DXN emission concentration EnTSFRT is as follows:
first, given input X∈R^{N×M}, N and M are number of samples and number of features, respectively; converting DXN emission concentration to an output of the TSFRT-III model f_{TSFRTI-III}^{j} (·) represented as aⱼ∈R^{N×1}; therefore, an output of J -th DXN emission concentrations TSFRT-III model {ƒ_{TSFRT-III}^{j}(·)}ⱼ₌₁^{J} can be expressed as a matrix A∈R^{N×J};
then, a pseudo-inverse is computed by employing the following optimization problem to estimate the weights with a smallest training error;
$${arg min}_{{W}_{L S M}^{J}} : {‖ {AW}_{L S M}^{J} - y ‖}^{2} + λ {‖ {W}_{L S M}^{J} ‖}^{2} \qquad ( 40 )$$
wherein W_{LSM} ^{J} is a weighted sum of squares constraint, λ is any given constraint coefficient in (0, 1); y is a sample output;
the above optimal result is calculated by using a Moore-Penrose inverse matrix to calculate the weight matrix, as follows:
when the number J of DXN emission concentration TSFRT-III models is greater than the number of samples N, a weight W_{LSM}^{J} is expressed as:
$${W}_{L S M}^{J} = {( {A}^{T} A + λ I )}^{- 1} {A}^{T} y \qquad ( 41 )$$
when the number J of DXN emission concentration TSFRT-III models is smaller than the number of samples N, the weight W_{LSM} ^{J} is expressed as:
$${W}_{L S M}^{J} = {{A}^{T} ( λ I + A {A}^{T} )}^{- 1} y \qquad ( 42 )$$
finally, an output of the DXN emission concentration EnTSFRT model is:
$$\hat{y} = {AW}_{L S M}^{J} = {[ {f}_{TSFRT}^{j} ( X ) ]}_{j = 1}^{J} {W}_{L S M}^{J} . \qquad ( 43 )$$
